(19) United States
(12) Patent Application Publication
(10) Pub. No.: US 2013/0026399 A1
(43) Pub. Date: Jan. 31, 2013

(54) VALVE

(71) Applicant: Daniel Paris, Sheffield (GB)

(72) Inventor: Daniel Paris, Sheffield (GB)

(21) Appl. No.: 13/558,039

(22) Filed: Jul. 25, 2012

(30) Foreign Application Priority Data
Jul. 25, 2011 (GB) 1112741.2

(51) Int. Cl. F16L 55/00

(52) U.S. Cl. 251/118

(57) ABSTRACT

A valve having a fluid block and bleed functions, includes an inlet part, an outlet part, a blocking part and a bleed part with at least one of the blocking and bleed parts being able to be removably connected to a remainder portion of the valve. In an alternative embodiment of the invention, at least one of the inlet and outlet parts includes a removable flange portion.

### BACKGROUND OF THE INVENTION

1. Technical Field of the Invention

The invention relates to valves for use in hydraulic applications.

2. Description of the Prior Art

Valves are known for use in hydraulic systems in order to control fluid flow. When there is a requirement to remove a component of the system, for instance, for maintenance purposes, the section of the system containing the component must first be isolated and secondly the pressure within the system must be safely reduced or vented. To carry out these actions, a valve with a combination of block and bleed functions is required.

Currently available valves having fluid block and bleed functions are of a one piece body construction and include a flanged inlet or outlet (or both) to connect the valve to the hydraulic system. If a different flange rating or valve combination is required, a completely new valve body must be stocked or manufactured. As a result there is a high inventory cost as well as a long lead-time because of the complexity of changing the valve.

### SUMMARY OF THE INVENTION

According to one aspect of the present invention, there is provided a valve having fluid block and bleed functions, the valve comprising inlet and outlet parts, a blocking part and a bleed part, at least one of said blocking and said bleed parts being removably connected to the remainder of the valve.

In another aspect of the present invention, there is provided a valve having fluid block and bleed functions, the valve comprising inlet and outlet parts, a blocking part and a bleed part, at least one of the inlet and outlet parts including a removable flange portion.

Preferably the inlet part includes a removable flange.

Preferably the inlet part includes housing with which the flange is in sealing engagement, the housing being provided with an insert which retains the flange in said sealing engagement.

Preferably the housing is in sealing engagement with the bleed part.

Preferably said bleed part is in sealing engagement with a blocking part.

Preferably said inlet, said blocking part and said bleed part have aligned bores extending therethrough.

Preferably said parts are connected together by means of elongate fasteners extending from the outlet part through intervening parts to said inlet part.

Preferably said elongate fasteners are secured to said housing of said inlet part.

The present invention also provides a method of modifying the functionality of a valve in accordance with the present invention, the method including removing one of said parts from the valve and replacing it with another such part compatible with the valve.

Other objects and features of the present invention will become apparent when considered in combination with the accompanying drawing figures, which illustrate certain preferred embodiments of the present invention. It should, however, be noted that the accompanying drawing figures are intended to illustrate only select preferred embodiments of the claimed invention and are not intended as a means for defining the limits and scope of the invention.

### BRIEF DESCRIPTION OF THE DRAWING FIGURES

In the drawing, wherein similar reference numerals and symbols denote similar features throughout the several views:

FIG. 1 is an elevational view illustrating a first embodiment in accordance with the present invention;

FIG. 2 is an elevational view illustrating a second embodiment in accordance with the present invention; and,

FIG. 3 is an elevational view illustrating the third embodiment in accordance with the present invention.

### DETAILED DESCRIPTION OF THE DRAWING FIGURES AND PREFERRED EMBODIMENTS

The present invention will be described, by way of examples only, with reference to the accompanying drawings.

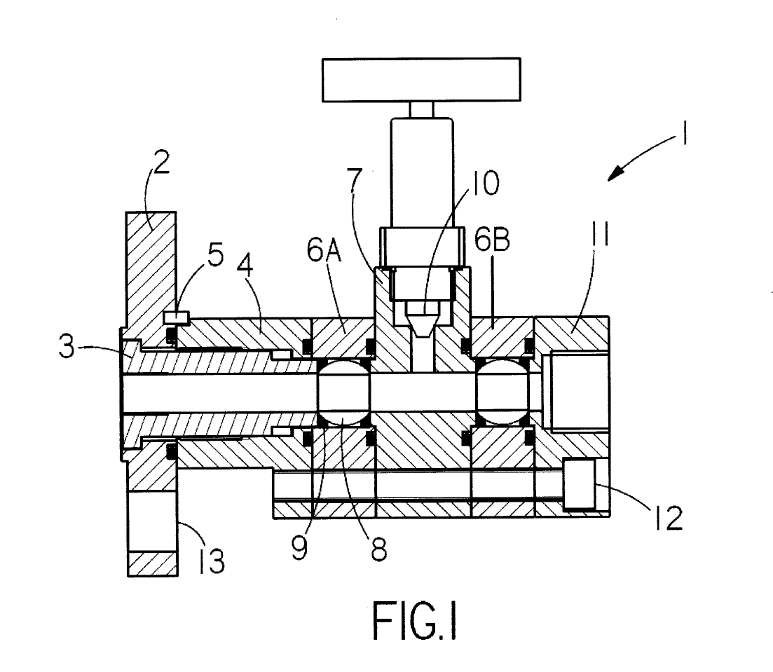

Referring to FIG. 1 of the accompanying drawings, there is illustrated a valve 1 having a double block and bleed functionality. The valve is provided with a flange 2 which, in use, is sealed to a hydraulic system by, for instance, a gasket (not shown). Flange 2 is provided with holes 13 which can be utilised to firmly attach the valve to the hydraulic system.

Flange 2 forms part of an inlet of which the other major components are a housing 4 and an insert 3. Insert 3 acts to retain the flange by means of a shoulder portion 3A engaging with a corresponding stepped portion of the flange. Insert 3 is retained within housing 4 by means threaded portions 4B provided on these components.

Insert 3 includes an internal hexagonal feature in its bore which is used to rotate the insert and thereby to firmly retain the flange in position.

A dowel pin 5, located in flange 2, locates in housing 4 and prevents rotation therebetween.

Valve 1 includes a blocking part 6A located adjacent the inner face of the inlet. Blocking part 6A is in the form of a ball valve module which locates radially on the insert, the insert housing carrying an o-ring 6B which provides sealing engagement with module 6A. Ball valve module 6A houses a ball 8 and seals 9 and functions as a conventional ball valve. Located adjacent ball valve module 6A is a needle valve module 7 which locates radially on module 6A, the latter being provided with an o-ring 6A which provides sealing engagement between module 6A and module 7.

Needle valve module 7 incorporates a needle valve 10 which can be closed down on a radial hole extending perpendicularly from the central bore of the valve. A cross drilled hole joins said radial hole to a further radial hole spaced at 90° circumferentially from said first mentioned hole.

Located adjacent needle valve module 7, on the opposite side to ball valve module 6A, is a further ball valve module 6B. Located adjacent to further ball valve module 6B, on the opposite side to needle valve module 7, is a top plate 11. Top plate 11 is provided with bolts 12 which extend through said top plate 11, ball valve modules 6A and 6B, needle valve module 7 and engage in screw threads in housing 4.

Top plate 11 forms the outlet to the valve and incorporates a threaded section 11A to enable the valve to be connected to the hydraulic system.

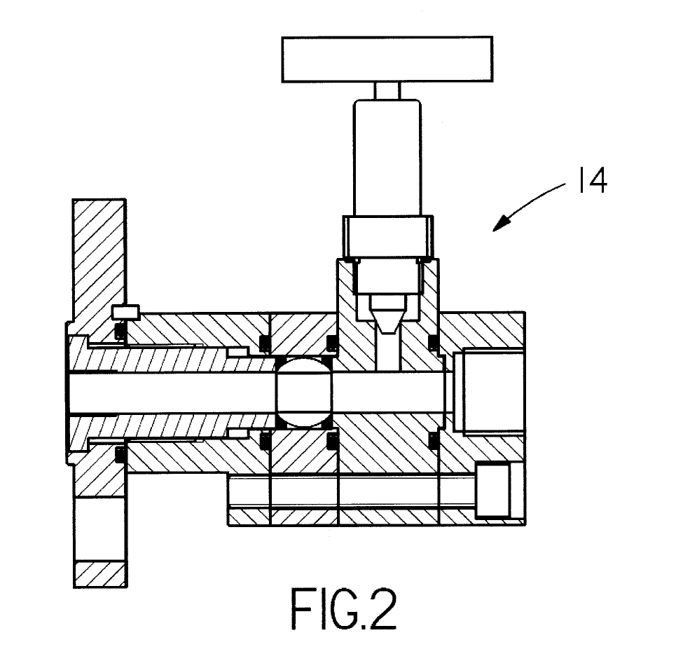

Referring to FIG. 2 of the accompanying drawings, a valve 14 is similar to the valve shown in FIG. 1, except that one of the ball valve modules is not present. The valve of FIG. 2 has a single block and bleed functionality.

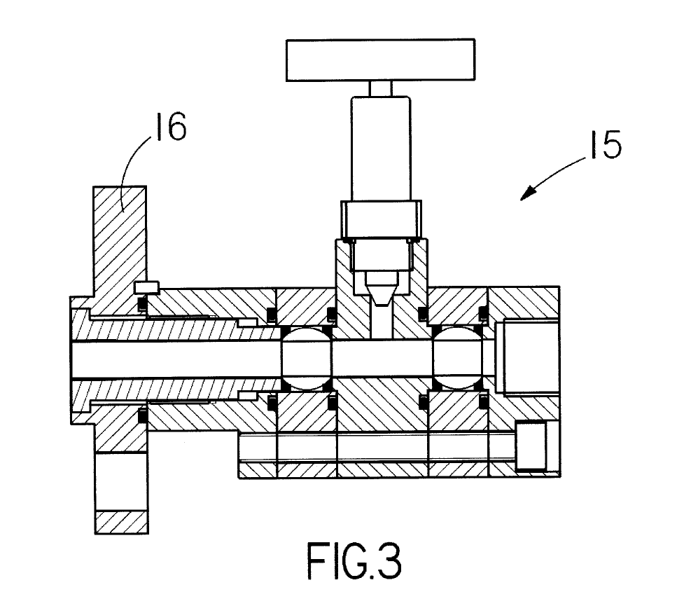

Referring to FIG. 3 of the accompanying drawing, a valve 15 according to the present invention is similar to that described above in relation to the valve of FIG. 1, that is to say, it has a double block and bleed functionality. The valve of FIG. 3 differs from that of FIG. 1 only in that the flange 16 replaces flange 2, flange 16 having a different pressure rating and or being of different dimensions.

While only several embodiments of the present invention have been shown and described, it will be obvious to those skilled in the art that many modifications may be made to the present invention without departing from the spirit and scope thereof.

What is claimed is:

1. A valve having a fluid block and bleed functions, comprising an inlet part, an outlet part, a blocking part and a bleed part with at least one of said blocking part and said bleed part being removably connected to a remainder portion of said valve.

2. The valve having a fluid block and bleed functions according to claim 1, wherein said inlet part includes a removable flange.

3. The valve having a fluid block and bleed functions according to claim 2, wherein said inlet part includes a housing with which said removable flange is in a sealing engagement, said housing being provided with an insert for retaining said removable flange in said sealing engagement.

4. The valve having a fluid block and bleed functions according to claim 3, wherein said housing is in sealing engagement with said bleed part.

5. The valve having a fluid block and bleed functions according to claim 4, wherein said bleed part is in a sealing engagement with a said blocking part.

6. The valve having a fluid block and bleed functions according to claim 5, wherein said inlet part, said blocking part and said bleed part have aligned bores extending therethrough.

7. The valve having a fluid block and bleed functions according to claim 6, wherein said inlet part, said outlet part, said blocking part and said bleed part are connected together via elongate fasteners extending from said outlet part, through said blocking part and said bleed part, and to said inlet part.

8. The valve having a fluid block and bleed functions according to claim 7, wherein said elongate fasteners are secured to said housing of said inlet part.

9. A valve having a fluid block and bleed functions; comprising an inlet part, an outlet part, a blocking part and a bleed part with at least one of said inlet part and said outlet part including a removable flange portion.

10. The valve having a fluid block and bleed functions according to claim 9, wherein said inlet part includes said removable flange.

11. The valve having a fluid block and bleed functions according to claim 10, wherein said inlet part includes a housing with which said removable flange is in a sealing engagement, said housing being provided with an insert for retaining said removable flange in said sealing engagement.

12. The valve having a fluid block and bleed functions according to claim 11, wherein said housing is in sealing engagement with said bleed part.

13. The valve having a fluid block and bleed functions according to claim 12, wherein said bleed part is in a sealing engagement with a said blocking part.

14. The valve having a fluid block and bleed functions according to claim 13, wherein said inlet part, said blocking part and said bleed part have aligned bores extending therethrough.

15. The valve having a fluid block and bleed functions according to claim 14, wherein said inlet part, said outlet part, said blocking part and said bleed part are connected together via elongate fasteners extending from said outlet part, through said blocking part and said bleed part, and to said inlet part.

16. The valve having a fluid block and bleed functions according to claim 15, wherein said elongate fasteners are secured to said housing of said inlet part.
